(19) United States
(12) Patent Application Publication
(10) Pub. No.: US 2008/0110217 A1
(43) Pub. Date: May 15, 2008

(54) Security System and Related Devices and Methods

(75) Inventors: Anthony ANDREWS, Rancho Santa Margarita, CA (US); Josefino Cruz DEL ROSARIO, Long Beach, CA (US); Eugene CHOO, Placentia, CA (US); Deborah L. MICHELLE, Mission Viejo, CA (US)

Correspondence Address: STOEL RIVES LLP - SLC, 201 SOUTH MAIN STREET, ONE UTAH CENTER, SALT LAKE CITY, UT, 84111, US

(73) Assignee: Targus Group International, Inc., Anaheim, CA (US)

(21) Appl. No.: 11/940,211

(22) Filed: Nov. 14, 2007

Related U.S. Application Data
(60) Provisional application No. 60/865,837, filed on Nov. 14, 2006.

(51) Int. Cl. E05B 73/00

(52) U.S. Cl. 70/58

(57) ABSTRACT

Disclosed are embodiments of systems for securing physical devices, such as portable computers or other electronic devices, to provide theft deterrence or prevention. In one embodiment of a system according to the invention, a security member is provided on an electronic device. A locking mechanism is then provided, which is configured to be releasably secured to the security member. In some embodiments, a lock sensor may also be provided to detect the presence of the locking mechanism. Embodiments of adapters for allowing pre-existing lock devices to operate and be used in conjunction with electronic devices configured with a security member are also disclosed.

### RELATED APPLICATIONS

This application claims the benefit under 35 U.S.C. §119(e) of U.S. Provisional Patent Application No. 60/865,837, filed Nov. 14, 2006, and titled “Security System and Method,” which is incorporated herein by specific reference.

### BRIEF DESCRIPTION OF THE DRAWINGS

Understanding that drawings depict only certain preferred embodiments of the invention and are therefore not to be considered limiting of its scope, the preferred embodiments will be described and explained with additional specificity and detail through the use of the accompanying drawings in which:

FIG. 1 is a perspective view of one embodiment of a security member incorporated into a portable computer.

FIG. 2 is a perspective view of a portable computer including another embodiment of a security member.

FIG. 3 is a perspective view of a portable computer including still another embodiment of a security member.

FIG. 4 is a perspective view of a portable computer including yet embodiment of a security member.

FIG. 5 is a perspective view of a portable computer including another embodiment of a security member.

FIG. 6 is a perspective view of a portable computer frame including a security member.

FIG. 7 depicts a piece of stamped sheet metal which may be used to form the frame of FIG. 6.

FIG. 8 is a perspective view of an embodiment of a locking head of a locking mechanism and an accompanying security member.

FIG. 9A is a perspective view of another embodiment of a locking mechanism.

FIGS. 9B and 9C illustrate the functionality of example internal components suitable for use with the locking mechanism of FIG. 9A.

FIG. 10A is a perspective view of a rear surface of another embodiment of a security member.

FIG. 10B is a perspective view of the front surface of the security member shown in FIG. 10A.

FIG. 10C is a top plan view of the security member of FIGS. 10A and 10B showing a security arm engaging a spring-loaded contact on the security member.

FIG. 11 is a top plan view of the internal components of another embodiment of a locking mechanism.

FIG. 12 is an exploded perspective view showing various components of the locking mechanism of FIG. 11.

FIG. 13 is a perspective view of a portable computer including an embodiment of retractable receptor which, in its extended configuration, serves as a security member.

FIG. 14 is a perspective view of a portable computer including another embodiment of a retractable receptor.

FIG. 15A is a perspective view of an embodiment of an adapter for connecting a non-conforming computer lock device with a security member.

FIGS. 15B and 15C illustrate the functionality of example internal components suitable for use with the adapter of FIG. 15A.

FIG. 16 is a perspective view of an opposite side of the adapter of FIG. 15 and also depicting a non-conforming computer lock device to be used with the adapter.

FIG. 17 is a perspective view of the internal components of another embodiment of an adapter.

### DETAILED DESCRIPTION OF PREFERRED EMBODIMENTS

In the following description, numerous specific details are provided for a thorough understanding of specific preferred embodiments. However, those skilled in the art will recognize that the invention can be practiced without one or more of the specific details, or with other methods, components, materials, etc.

In some cases, well-known structures, materials, or operations are not shown or described in detail in order to avoid obscuring aspects of the preferred embodiments. Furthermore, the described features, structures, or characteristics may be combined in any suitable manner in one or more embodiments.

The present invention is directed toward a system and method for securing physical devices as a mechanism for theft deterrence or prevention. In another embodiment of the invention, systems and methods are provided to support electronic security for a variety of devices. Before describing the invention in detail, it is useful to describe an example application with which the invention can be implemented. One such example is that of a computing device such as, for example, a workstation, personal computer, laptop, or notebook computer. In numerous environments, including, for example, home and office environments, it may be desirable to provide a measure of security for computing devices including, for example, those computing devices noted above. Additionally, it may be desirable to provide security measures for computing accessories such as monitors, printers, fax machines, as well as other for other electronic devices, accessories, or office equipment.

As will be apparent to one of ordinary skill in the art after reading this description, the present invention can be implemented to provide, in one embodiment, physical security for such computing devices and accessories, as well as for other devices. In another embodiment, security measures can be included to provide electronic security (for example, electronic access control or data security) for such devices as well. From time to time, the present invention is described herein in terms of this example application of computing devices and accessories. More particularly, for ease of discussion and to facilitate a full understanding of the invention, various embodiments are described in terms of providing physical and electronic security for portable computing devices or electronic devices, such as portable computers. Description in terms of this example application is provided to allow the various features and embodiments of the invention to be portrayed in the context of an exemplary application. After reading this description, it will become apparent to one of ordinary skill in the art how the invention can be implemented in different alternative applications and environments. For example, after reading this description, one of ordinary skill in the art will understand how to implement the described invention to provide physical or electronic security for a wide variety of devices.

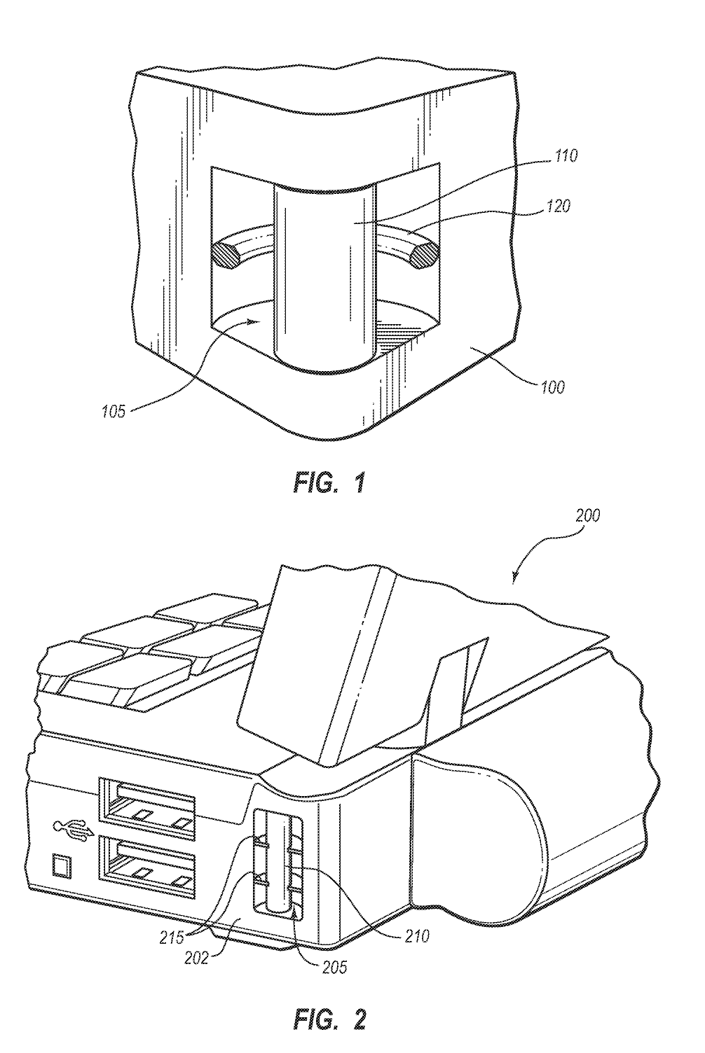

FIG. 1 is a diagram illustrating one embodiment of the invention in which a security member 110 is provided in a recessed portion 105 of a portable computer 100 to provide a physical mechanism to which a locking device (not illustrated) can be secured. In the embodiment depicted in FIG. 1, the security member comprises a post 110. The locking device may include, for example, a cable, chain, strap, or other locking mechanism that can be slipped through the recess and secured about the post. The opposite end of the locking mechanism can then be secured to a floor, wall, piece of furniture, or other relatively immovable object. In one embodiment, rather than a simple cable or other similar mechanism, the locking mechanism may include multiple components.

For example, in one embodiment, the locking mechanism may include a locking head that fastens to the security post. A cable or other mechanism can attach to or be integral with the locking head. Thus, when the cable is secured to an immovable object on one end and to the locking head on the other, and when the locking head is secured to the electronic device, such as computer 100, the device can be secured to the relatively immovable object. As another example, in electronic embodiments, the locking mechanism can include an electronically actuated locking head to provide electronic security (for example, as an electronic key). A cable or other like fastening mechanism can also be provided with electronic key embodiments.

In the embodiment illustrated in FIG. 1, the security member is illustrated as a substantially cylindrical post 110 securely affixed in a corner of the portable computer. Although a cylindrical post is illustrated, other shapes and dimensions of posts can be provided without departing from the spirit and scope of the invention. As such, the term “post” is not intended to limit the scope of the claims to a post-like structure, as other shapes and configurations can be used. In a preferred embodiment, the security member or post is affixed to the portable computer such that it can not be easily removed, thereby providing an anchor point for the locking mechanism. The degree to which the security post can be secured to the portable computer (or other electronic device in other applications) can be determined based on the level of security desired for the given application.

For example, in one embodiment, the security member can be molded from the same materials as the housing of the device to be secured. For example, in terms of a portable computer, the security member can be fashioned as an integrated piece of the housing of the portable computer. However, depending on the dimensions and shape chosen for the member and anchoring positions, as well as the type of material used to fabricate the housing, such a security member might be defeated by a would-be thief who might attempt to break the security member and free the secured device from the locking mechanism.

Therefore, in another embodiment of the invention, a more substantial frame can be provided to anchor the security member in a more secure fashion. For example, metals or other strong materials can be used to fashion the security post as well as to form a frame to which the post is secured. In one embodiment, magnesium alloy can be used to form the frame, the security post, or both. The frame can be integrated with the housing in such a way as to require a more substantial amount of force to defeat the mechanism. For example, the frame can be integrated or encased in the housing in such a way that forced removal of the security device would result in a significant amount of damage to the secured device, thereby diminishing the value of the secured device were it to be stolen, which diminishes the motivation to steal the device.

In another embodiment of the invention, the frame can include an integrated security post. For example, an electronic device, such as a portable computer, can include an internal die cast frame. The frame can be cast metal, e.g., cast magnesium alloy, or other suitable material. The security post can be made during the casting process. In this way, the need for a separate security post that would be attached to the frame during assembly can be eliminated. Thus, in this embodiment, manufacturing cost and assembly time can be saved.

Although the embodiment illustrated in FIG. 1 depicts the security post 110 as being affixed to a corner of the electronic device 100 within a recessed portion 105, in other embodiments, the security post can be provided in a recess on a sidewall, on the top or bottom of the device, or along another surface of the device. Of course, in still other embodiments, the post may be provided in a non-recessed area of the frame, or elsewhere on the electronic device.

In the embodiment illustrated in FIG. 1, a lock sensor 120 is also provided to detect the presence of the locking mechanism. The lock sensor can include a module to respond to events, such as insertion and/or removal of the locking mechanism from the security member. For example, the lock sensor 120 can be configured to, upon detection of the removal of the locking mechanism, trigger an alarm, generate an alert message, alert the user or others of the event, disable the device, limit or prohibit access to the device, shut down the device, lock files on the device, or perform other appropriate actions in response to the event.

For example, in one embodiment, in applications where the device being secured is an electronic device, the lock sensor can be configured to disable or inhibit operation of the electronic device when the locking mechanism is removed. As a further example in terms of the portable computer application, in one embodiment, a module can be provided with the portable computer to detect the state of the lock sensor to determine whether the security mechanism is properly in place. The module can be configured to respond in a variety of different ways as may be desired for a given application.

For example, in one embodiment, the module can be configured to require the use of a password to gain access to the portable computer in the absence of a locking mechanism. As another example, in another embodiment, the module can be configured to disable operation of the portable computer in the absence of the locking mechanism. As a further example, the module could be configured to restrict access to one or more portions of the portable computer, restrict access to some or all of the data, shut down the portable computer, sound an alarm, generate an alert message to a designated recipient, destroy sensitive data, or take other desired action upon removal of the locking mechanism. As these examples serve to illustrate, various electronic mechanisms can be put in place to inhibit, restrict, or disable operation of the electronic device in the absence of the locking mechanism. Thus, an additional layer of security can be provided.

FIG. 2 is a diagram illustrating another example implementation of a security device in accordance with another embodiment of the invention. Referring now to FIG. 2, the security post 210 and recess 205 are configured along a sidewall 202 of the portable computer 200. Anchor members 215 may be provided to further secure the security post 210 to the structure of the portable computer 200 while leaving sufficient room in the recess area 205 behind the post 210 to receive a locking mechanism for engagement with post 210. Anchor members 215 may be welded, integrally molded, bolted, or otherwise fixedly attached to the computer 200 and/or the security post 210. In some embodiments, the anchor members may be fastened to or integral with the computer but not the security member. The security member may, in such embodiments, be positioned within the anchor members such that the anchor members nevertheless prevent the security member from being removed from the electronic device. Anchor members 215 may also have a cutout portion that conforms, at least in part, to the shape of the security post 210 such that anchor members 215 allow security post 210 to be received snugly therein. Although not illustrated in FIG. 2, one or more lock sensors can also be included in this embodiment (as well as in any other embodiment) to provide detection of the locking mechanism.

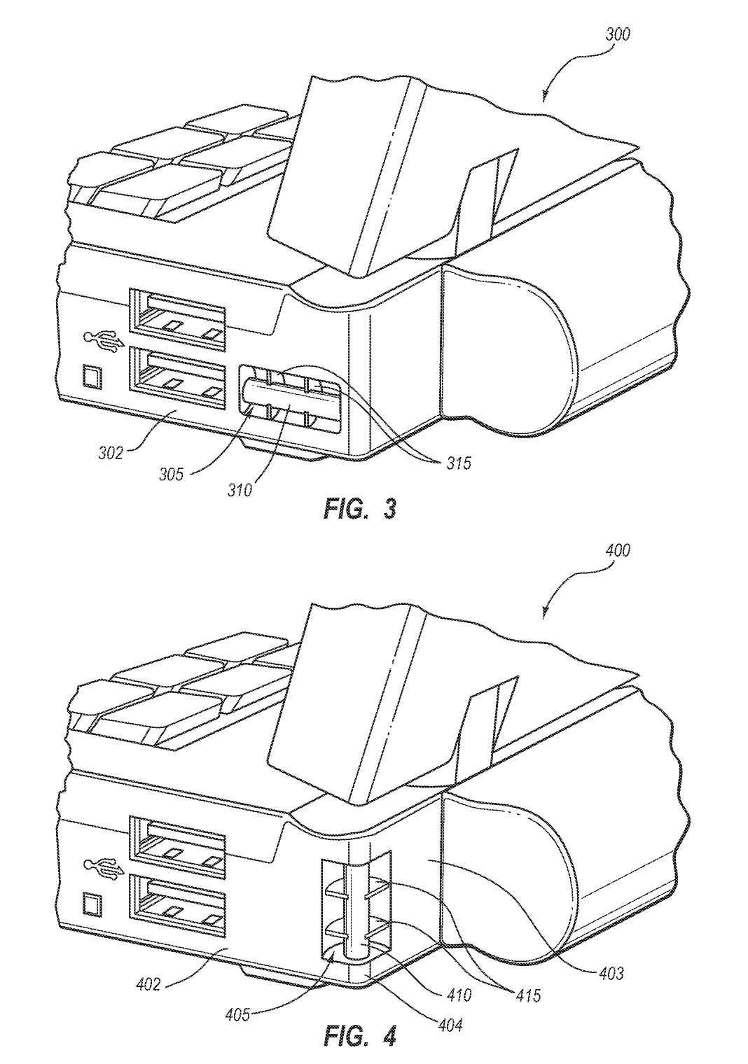

FIG. 3 illustrates another example embodiment of a laptop or portable computer 300 including a recessed portion 305 formed in a sidewall 302 thereof. Recessed portion 305 is configured to fixedly receive a security post 310, which is anchored into place via anchor members 315. The example embodiment illustrated in FIG. 3 is similar to the example implementation illustrated in FIG. 2, except the security post 310 is configured in a horizontal orientation as opposed to the vertical orientation of the embodiment of FIG. 2.

FIG. 4 illustrates yet another implementation of a security post 410 integrated with a portable computer 400 in accordance with another embodiment of the invention. This example implementation illustrates the security post affixed at a corner 404 of portable computer 400 with the recess 405 having openings on adjacent sides of the corner 404. The corner 404 is at the intersection of sidewalls 402 and 403 of the housing of computer 400. Once again, anchor members 415 are provided, which are used to facilitate securing post 410 to computer 400.

FIG. 5 illustrates a perspective view of another embodiment of a security post 510 mounted in a recess 505 formed within a corner 504 of a portable computer 500. This embodiment includes two lock sensors 520 on opposite sides of the security post 510, which, as previously described, may operate in conjunction with a module to provide an additional layer of security to the device. As those having ordinary skill in the art will appreciate, the module may be implemented in software, hardware, firmware, or a combination of the foregoing.

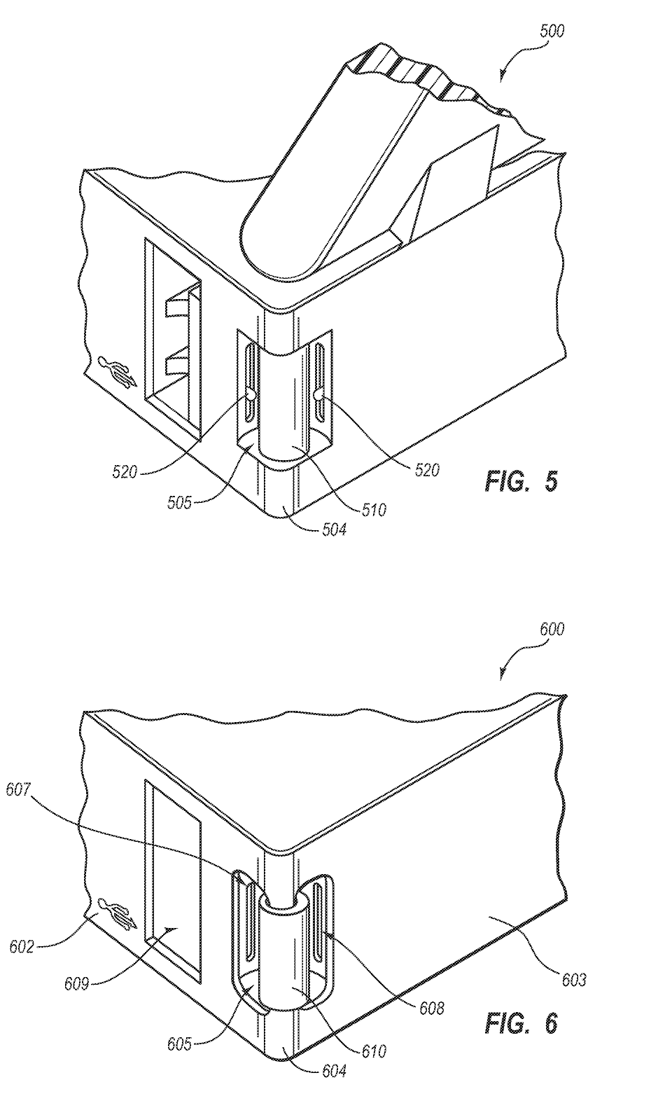

FIG. 6 illustrates an example of a frame 600 fashioned so as to provide a recess 605 at a corner 604 of an electronic device. Recess 605 is defined, at least in part, by openings 607 and 608 formed in sidewalls 602 and 603, respectively, of frame 600. In the example illustrated in FIG. 6, the frame 600 is fashioned from stamped sheet metal folded to provide a rigid structure at the corner 604 of a portable computer. This stamped sheet metal can be configured to provide openings to allow positioning of data ports such as, for example, a USB port, as well as openings for various configurations of lock sensor. Accordingly, opening 609 formed in sidewall 602 may be used to provide a data port opening in the finished product. The example in FIG. 6 also illustrates a cylindrical security post 610 wrapped around the corner 604 of the sheet metal frame 600. In one embodiment, such a frame can be encased in the housing of the subject device to provide sufficient strength to inhibit forced removal of the locking mechanism. Referring back to FIG. 5 momentarily, FIG. 5 provides an example of what the frame of FIG. 6 may look like encased in a portable computer housing.

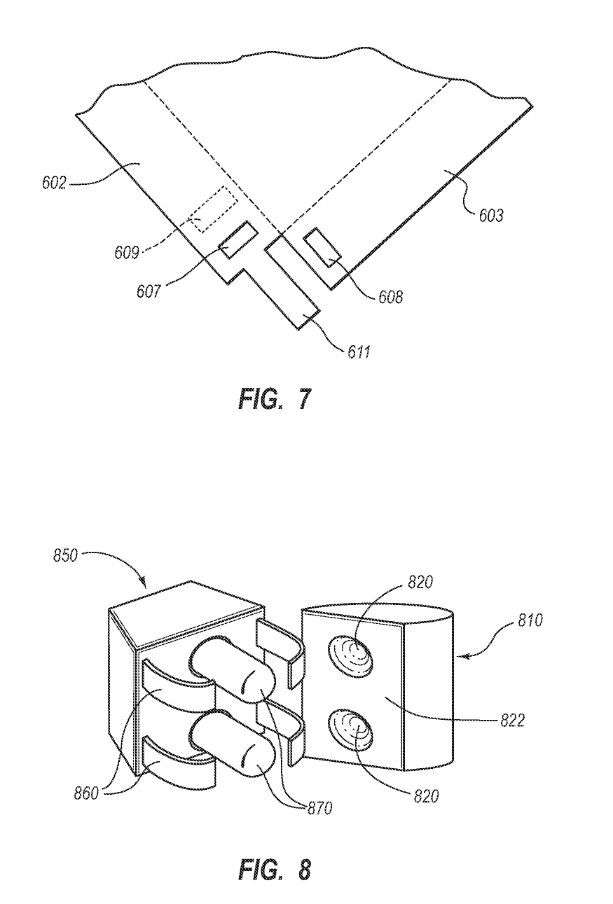

FIG. 7 is a diagram illustrating an example of a sheet metal cutout that can be properly bent to form the frame illustrated in FIG. 6. In this example, the sheet metal may be folded along the dotted lines of FIG. 7 to form sidewalls 602 and 603. Metal strip 611 may be cut from the sheet metal, inserted through recess openings 607 and 608, and wrapped around the resultant corner 604 to create the security post 610. Tabs may be retained from stamping out any of the various openings to provide the backing for the recess 604 and the various joints can be welded or otherwise secured together to provide a rigid frame structure. Also illustrated in FIG. 7 is the stamped region 609 which may ultimately form a USB port opening, as illustrated in FIG. 6. Of course, a USB port opening or other opening in the frame can be provided in accordance with the layout of various ports, sockets, or other access points on the portable computer.

In the presented embodiments, a locking sensor can be provided in a number of different forms to sense the presence of the locking mechanism. For example, in one embodiment, mechanical switches can be used to detect the presence of the cable or other locking mechanism in the recess. Alternatively, electrical, optical, magnetic, electromagnetic, or other detection mechanisms can be used to detect the presence of the locking mechanism. In a further embodiment, electrical contacts or another communication interface can be provided to enable communications between the locking mechanism and the secured device. In one embodiment, the locking mechanism can be coded (for example, with a passcode or other data) and the lock sensors configured to detect the presence of the properly coded locking mechanism.

For example, the locking mechanism can include RFID (radio frequency identification) or near-field technology with a security code embedded therein or other forms of data storage and communications (including simple memory circuits and electrical interfaces). As such, the locking mechanism can be configured to check for the presence of the proper security code before recognizing the locking mechanism as a valid locking mechanism. The RFID tag or other technology can be embedded in the locking mechanism such that it cannot be easily removed and transported away with the portable computer in the event of a theft. For example, in one embodiment, the codes are embedded in a locking head of the locking mechanism. As another example, a security cable or similar mechanism can be encased in a conductive coating such as, for example, carbonized rubber. The coating may be provided with a particular conductivity that may be sensed by the locking sensor(s). In this example, the locking sensors can be configured to check for the correct level of conductivity to authenticate the locking mechanism.

In embodiments using coded locking mechanisms, the system can further be configured such that the user initiates a locking sequence that recognizes the code embedded in the locking mechanism and configures the device so as to operate only when the proper code is recognized. As such, an authorized user can program or configure the device to only work with a particular locking mechanism or only particular types of mechanisms. Such an implementation may be useful to avoid defeating the mechanism by providing lock “substitutes” for the authorized locking mechanism.

Additionally, the system can be configured to require a password or other security code, or a security operation, to be entered/performed each time the locking mechanism is removed from and/or replaced in the recess, or each time the locking mechanism is otherwise engaged and/or disengaged with the secured device. With such safeguards, the invention can be implemented in such a way that the electronic locking mechanism is not defeated simply by replacing a locking mechanism after the originally secured locking mechanism is removed. This too can provide an added measure of security against removal of the locking mechanism and replacement of a substitute by a thief in an attempt to “fool” the lock sensors. As these examples illustrate, the electronic locking mechanisms can provide a measure of security in and of themselves, without attachment of a cable or other physical locking structure. Of course, attachment of such a structure can provide an added layer of security.

FIG. 8 illustrates an additional embodiment of a security member 810, along with an embodiment of an accompanying locking mechanism 850. In the depicted embodiments, the security member 810 is in the form of a post, and the locking mechanism 850 comprises a locking head. The illustrated embodiment includes both electrical contacts and security arms to provide physical and electronic security. More particularly, security post 810 comprises electrical contacts 820 and locking mechanism 850 comprises electrical contacts 870 which are configured to mate with contacts 820. A cable or other like structure (not illustrated) can be secured to the locking mechanism head to secure the device to an object.

As illustrated in FIG. 8, the security post can be constructed so as to have at least one flat or relatively flat side such that the outer surface of the security post is relatively flush with the outer surface of the laptop or other electronic device with which it is integrated. FIG. 8 illustrates a security post 810 having a relatively flat planar surface 822. The security post 810 of FIG. 8 also includes one or more electrical contacts. These electrical contacts 820 can be used to mate with corresponding contacts on a locking mechanism to provide a mechanism by which the presence of the locking mechanism can be sensed. Thus, in one embodiment, the one or more contacts are used to simply sense the presence or absence of a locking mechanism mated to a security post. In another embodiment, the contacts can be used to transfer data between the secured device and the locking mechanism. In such embodiments, security codes or other information can be stored in the locking mechanism and the security information read by the security post and/or the secured device to determine whether the locking mechanism is a locking mechanism which has been registered for and/or approved for the secured device. Thus, if a locking mechanism is removed or destroyed, it may be difficult for a would-be thief to replace it with a substitute locking mechanism not having the proper security information. Such mechanisms might be used to hinder one's ability to fool the security system.

The contacts 820 and 870 illustrated in FIG. 8 are cylindrical contacts, such as a banana plugs and jacks or RCA plugs and jacks. After reading this description, it would become apparent to one of ordinary skill in the art how other contacts may be provided. It will also become apparent to one of ordinary skill in the art how alternative communication interfaces can be provided between the locking mechanism and the electronic device including, for example, wired or wireless communications interfaces of various forms. In yet a further embodiment, the contacts can be placed in a recessed portion of the device to be secured or on a surface of the device to be secured, and the locking head configured to make appropriate contact.

The locking mechanism 850 depicted in FIG. 8 also illustrates an example configuration of security arms 860 that can be used to latch onto the security post 810 of a secured device. In some embodiments, the security arms and/or another means for engaging a locking mechanism with a security member, can be actuated via a button, lever, switch, dial, or the actuation may be employed manually by squeezing or otherwise manipulating the arms around the security member. In other embodiments, key locks, combination locks, and/or other locking mechanisms may be used to engage and release security arms or another engagement means.

In yet another embodiment, security arms can be activated (engaged or disengaged) based on signals communicated from the secured device to the locking mechanism (for example, using the above-described contacts). Thus, in one example, a password, PIN code, or other security code or command can be input by the user of the electronic device to authorize the engaging or disengaging of the security arms or other engagement mechanism to secure the locking mechanism to the security post or to release the locking mechanism from the security post. As such, password protection or other similar protection can be used to control the locking and/or unlocking of the secured device. Additionally, or alternatively, biometric sensors and/or other mechanisms can be used to authenticate the validity of the user attempting to actuate the mechanism.

Although the mating surfaces of the security post and the locking mechanism are illustrated as substantially planar in FIG. 8, other mating surfaces can be provided as well. Likewise, although not illustrated in FIG. 8, a locking mechanism can be provided without security arms or other engagement mechanisms, such as simply providing an electronic lock. In such embodiments, the electronic lock may exchange electronic information with the secured device to detect the presence of a properly-coded key. Thus, the locking mechanism illustrated in FIG. 8 can combine physical security through the use of a cable or other attachment mechanism to attach the locking mechanism to a relatively immovable object with electronic features. Alternatively, when used as a key without fastening the locking mechanism to an immovable object, the locking mechanism can be removed and securely retained by the authorized user to prevent unauthorized access to the machine. As such, in some embodiments, the secured device may be capable of being removed from a specified premises but is rendered inoperable without the presence of the keyed locking mechanism.

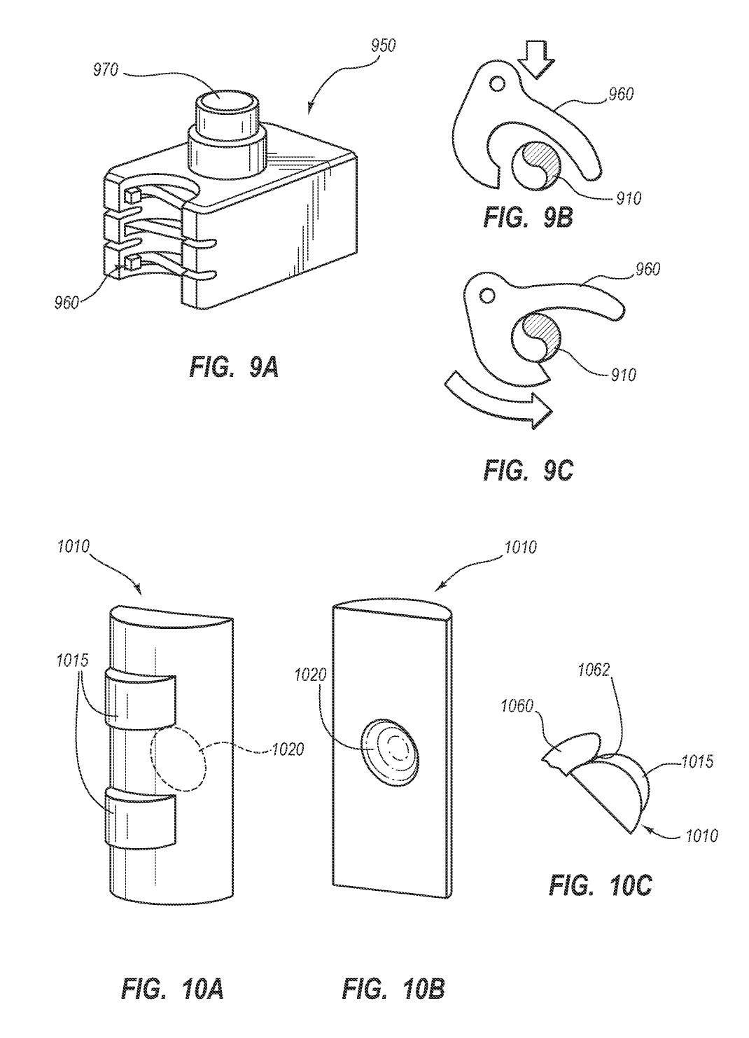

FIGS. 9A-9C illustrate yet another embodiment of a locking mechanism 950 that can be provided for integration with a security post or another security member. In the embodiments illustrated in these figures, a latching mechanism 960 is provided to engage the security member to prevent removal of the locking mechanism therefrom. In one embodiment, the engagement mechanism can be implemented as a self-latching mechanism wherein security devices secure themselves automatically around the security member upon insertion of the locking mechanism. In some embodiments, a mechanism can be implemented similar to those used in door latches of automobiles. For example, U.S. Pat. No. 4,892,339 titled “Power-closing motor-vehicle door latch” contains disclosure that may be useful in providing a self-latching mechanism suitable for use in connection with embodiments of the invention disclosed herein. U.S. Pat. No. 4,892,339 is hereby incorporated by reference in its entirety.

A release button 970 or other latch actuation mechanism can be provided to release the engagement mechanism to allow for removal of the locking mechanism. As shown in FIGS. 9B and 9C, latching mechanism 960 may be configured such that the force associated with pushing latching mechanism 960 against a security post 910 rotates a locking arm around security post 910. As those having ordinary skill in the art will appreciate, latching mechanism 960 may then be locked into place using known structures to prevent security post 910 from being pulled out of engagement with latching mechanism 910. Release button 970 may then be used to release latching mechanism 960 and allow for disengagement of the device with security post 910. Key locks, combination locks, electronic locking mechanisms or other locks can also, or alternatively, be included to prevent actuation of the engagement mechanism without approval or authority. Additionally, electronic locking features can be provided with this embodiment as well to provide electronic key features similar to those discussed above.

The security member and/or recessed portion can be provided in a variety of dimensions depending on the device to be secured, and the physical characteristics desired. For example, in some embodiments, the dimensions are relatively small such that the device can be utilized with a relatively small electronic device in an unobtrusive fashion. In particular, in one embodiment, the recess may be configured such that it is about 12 millimeters in length and about 6.5 millimeters in width, and the security post may be configured such that it ranges from about 2.5 millimeters to about 3 millimeters in diameter. As will be apparent to one of ordinary skill in the art after reading this, countless other dimensions can be provided in alternative embodiments.

Contacts can be placed in various locations on the security post or in the recess such that they can be properly engaged with corresponding contacts on the locking mechanism. For example, contacts do not need to be positioned on the face of the security post. Instead, one or more contacts can be positioned on side and/or rear surfaces of the security post, in the recess itself, or elsewhere on the secured device. Contacts may be spring-loaded in some embodiments to provide enhanced connectivity. In addition, contacts can also be provided on security arms or the security arms themselves can be configured as contacts to mate with corresponding contacts on the security member.

FIGS. 10A-10C illustrate an additional configuration for providing contacts (spring-loaded or otherwise) on front and/or rear surfaces of a security post 1010. More particularly, security post 1010 includes biased contacts 1015 on a rear surface of the post 1010. As illustrated in FIG. 10B, the front of security post 1010 may be configured with a concave contact 1020 configured to mate with a corresponding element of a locking mechanism. Of course, other embodiments are contemplated in which the front of the post or security member does not comprise any contacts. Instead, the biased contacts 1015 may be configured to indicate to the electronic device that the device is secured and/or unsecured. Thus, contacts 1015 may be communicative contacts or, alternatively, contacts 1015 may comprise only sensory contacts. Communicative contacts may then be provided by concave contact 1020 on the front surface of security post 1010 if desired.

FIG. 10C illustrates how a security arm may be configured with a feature that facilitates pushing down contacts 1015. More particularly, security arm 1060 includes an indent 1062 which provides for a more even force with which to depress contact 1015. Of course, other types of such features are contemplated. For example, a knob, protrusion, or the like may be included instead of, or in addition to, indent 1062.

As these and the other examples herein illustrate, various configurations for communicative or sensory contact can be provided to enable the locking mechanism to communicate with an electronic device or to allow the electronic device to sense the absence or presence of the locking mechanism. Where contacts are spring-loaded and placed so as to engage security arms or other elements of a locking mechanism, the arms may be shaped so as to assist in engaging the connectors or in tensioning spring-loaded contacts, as described above.

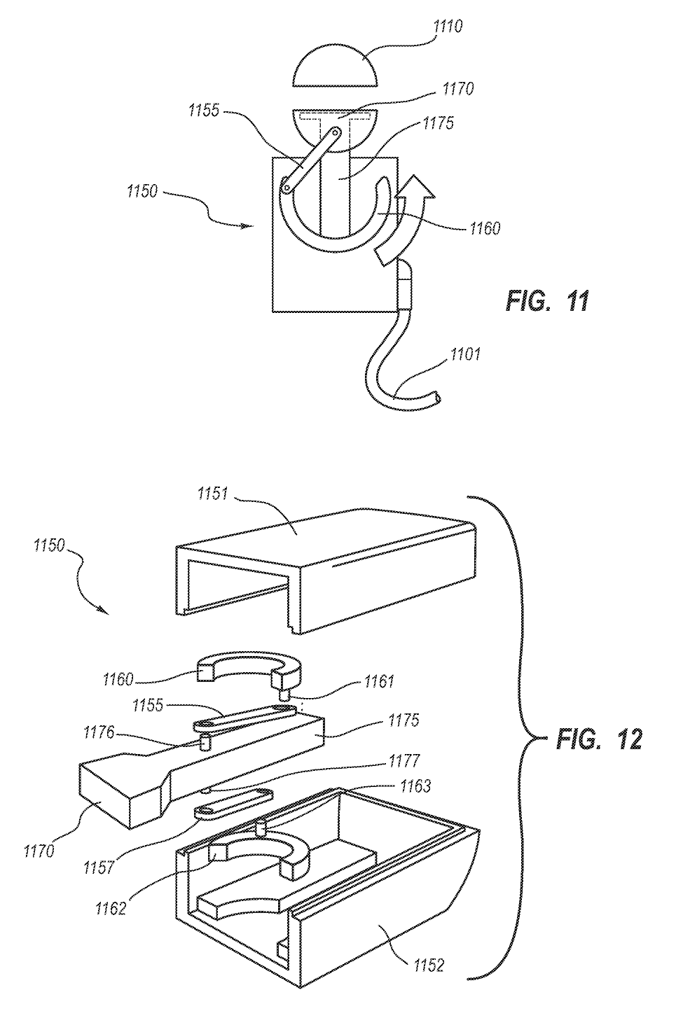

Electronic, electromechanical, or mechanical actuation can be used to engage the security arms or another engagement mechanism to secure the locking mechanism to the security post. An example embodiment of a mechanical locking mechanism is illustrated in FIGS. 11 and 12. Referring now to FIG. 11, an arm, or rod, structure can be configured to extend from a locking mechanism 1150 to allow for engagement with a security post 1110, as indicated by the arrow in FIG. 11. Thus, the embodiment of FIG. 11 includes an actuating linkage 1155 configured to facilitate engaging a security arm 1160 around security post 1110. The force needed to rotate security arm 1160 around the security post 1110 may result from pushing a contact 1170 against the security post 1110. If desired, a corresponding contact or slot may be provided in the security post 1110 configured to receive the contact 1170 of the locking mechanism 1150.

To further illustrate the motion of the locking mechanism 1150 of FIG. 11, contact 1170 may be configured to retract from an extended configuration to a retracted configuration upon engagement with security post 1110. A rod 1175 may be connected with the contact 1170 to provide additional durability if desired. Rod 1175 may also be spring-loaded if desired. Pushing contact 1170 against security post 1110 causes rotational movement of one or more security arms 1160, via linkage 1155, thereby causing security arm(s) 1160 to engage the security post 1110. Other simple hinged connectors can be provided to allow a security arm or the like to rotate around or otherwise move to engage a security post, as those having ordinary skill in the art will appreciate. In other embodiments, channels or the like can be used to guide the components for proper engagement and disengagement of the locking mechanism with a security member. In addition, as previously described, the surface(s) of the locking mechanism which contact the security member may also be configured and shaped so as to mate with the corresponding surface(s) of the security member if desired.

As described above, various lock arrangements can be used to secure the locking mechanism to the security post. Additionally, a cable can be provided to secure the locking mechanism to a relatively immovable object, such as cable 1101 shown in FIG. 11. In some embodiments, dual opposing security arms may be provided, both of which are configured to rotate around or otherwise engage a security post as the locking mechanism is pushed into the security post.

For example, FIG. 8, illustrates an embodiment providing multiple security arms. As another example, FIG. 12 illustrates an exploded view of the locking mechanism 1150 described above with reference to FIG. 11. Unlike FIG. 11, FIG. 12 depicts not only arm 1160, but also arm 1162 (of course, just a single arm may be provided in some embodiments). In the embodiment of FIG. 12, two semi-circular security arms, an upper security arm 1160 and a lower security arm 1162 are provided, both of which are configured to engage a security post or security member when the locking mechanism 1150 is pushed against the security post. As illustrated, the locking mechanism 1150 includes an upper housing 1151 and a lower housing 1152. The push rod 1175 may be configured to slide on a track or groove within the housing. Push rod 1175 may also be spring-loaded such that, when the locking mechanism 1150 is removed, the contact 1170 is extended and, when the locking mechanism 1150 is engaged, push rod 1175 is pressed against a spring (not illustrated). As illustrated, connecting pins may also be provided to connect the upper and lower linkages 1155 and 1157, respectively, to push rod 1175 and to the upper and lower security arms so as to enable the mechanism to operate in response to extension and retraction of the push rod 1175. More particularly, locking mechanism 1150 is provided with a first connecting pin 1176 on the upper surface of push rod 1175, a second connecting pin 1177 on the lower surface of push rod 1175, a third connecting pin 1161 used to connect upper linkage 1155 to upper security arm 1160, and a fourth connecting pin 1163 to connect lower linkage 1157 to lower security arm 1162.

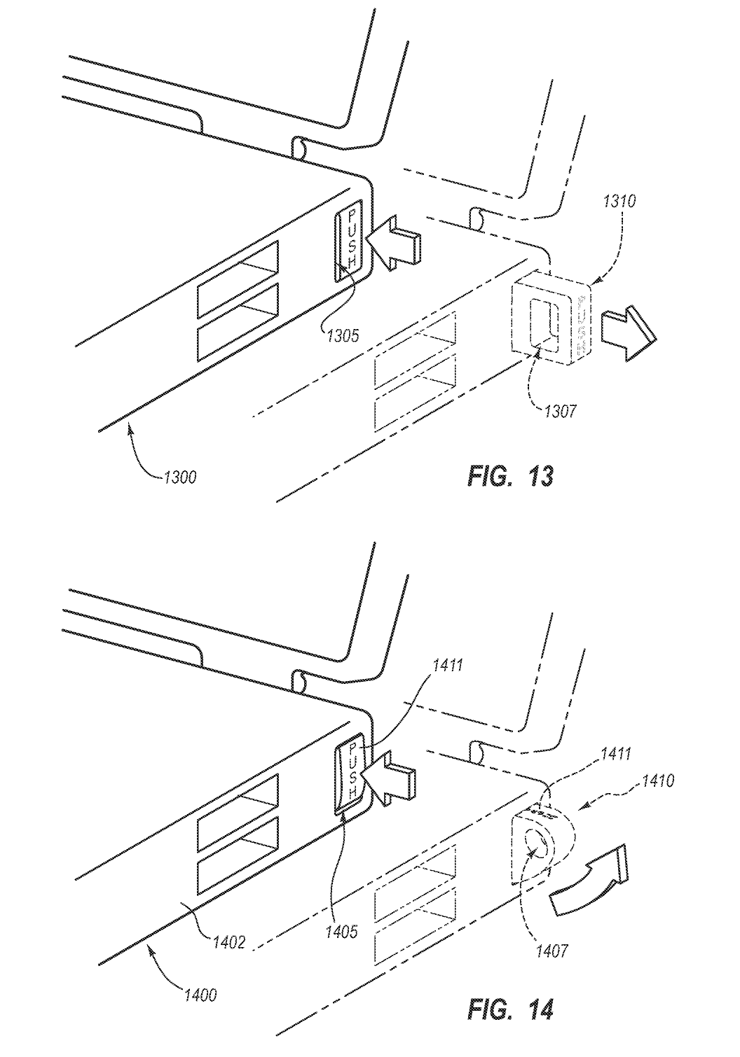

FIGS. 13 and 14 illustrate additional alternative embodiments of the invention. In these figures, a retractable receptor is provided to receive the locking mechanism. Such a receptor can be provided to be in a retracted configuration in the housing when not in use and to pop out or extend from the housing in an extended configuration to present the user with an aperture to accept the locking mechanism. Although not illustrated in FIGS. 13 and 14, these embodiments can also include lock sensors to detect the presence of a locking mechanism positioned through the aperture. Like the other embodiments, the retractable aperture can be fashioned in such a way that it cannot be easily removed from the portable device without damage thereto. Strong material, such as metals, metal alloys, and the like, can be used to form the receptor and also, in some embodiments, for an embedded frame within the device to adequately secure the extendable receptor to the electronic device. The pop-out mechanism can be spring-loaded for ease of extension if desired. In some embodiments, the retractable receptor in the retracted configuration may be configured to be extended to the extended configuration by applying a force towards the recess to unlock the retractable receptor and allow the retractable receptor to automatically extend to the extended configuration. The force for extending the retractable receptor may be provided by a spring or other biasing element.

As FIG. 13 illustrates, in one embodiment the lock holder can extend straight out from a recess in which it rests. Thus, laptop computer 1300 includes a recess 1305 in which an retractable receptor 1310 fits. Retractable receptor 1310 forms an aperture 1307, through which a locking mechanism (not shown) may be positioned to secure the computer 1300. As also shown in FIG. 13, aperture 1307 is accessible only in the extended configuration. It should be understood that retractable receptor 1310 comprises a “security member” in the extended configuration.

FIG. 14 illustrates another embodiment in which the retractable receptor is configured to pivot out, rather than extend straight out, of a recess. Thus, computer 1400 includes a recess 1405 configured to allow a retractable receptor 1410 to extend between a retracted configuration within the recess 1405 and an extended configuration in which it extends from the recess 1405. However, retractable receptor 1410 pivots out of recess 1405 such that surface 1411, which is positioned parallel to sidewall 1402 in the retracted configuration, pivots up such that it is perpendicular to sidewall 1402 in the extended configuration. As the examples in FIGS. 13 and 14 serve to illustrate, a variety of other mechanisms for providing a retractable receptor for the locking mechanism may be readily developed by those of ordinary skill in the art after having received the benefit of this disclosure.

As stated above, in one embodiment, the locking mechanism used to engage the recess or aperture can include mechanisms such as, for example, a cable made from high-tensile steel, aircraft steel, or other strong material resisted to cutting or breaking. The material may be encased in PVC or other like material which can, for example, provide a better aesthetic appearance as well as protect the internal cable from exposure to the environment. Any of a number of alternative locking mechanisms including, for example, cables, chains, bands, and the like, may be used to fulfill the function of the locking mechanism and/or may be connected with the locking mechanisms.

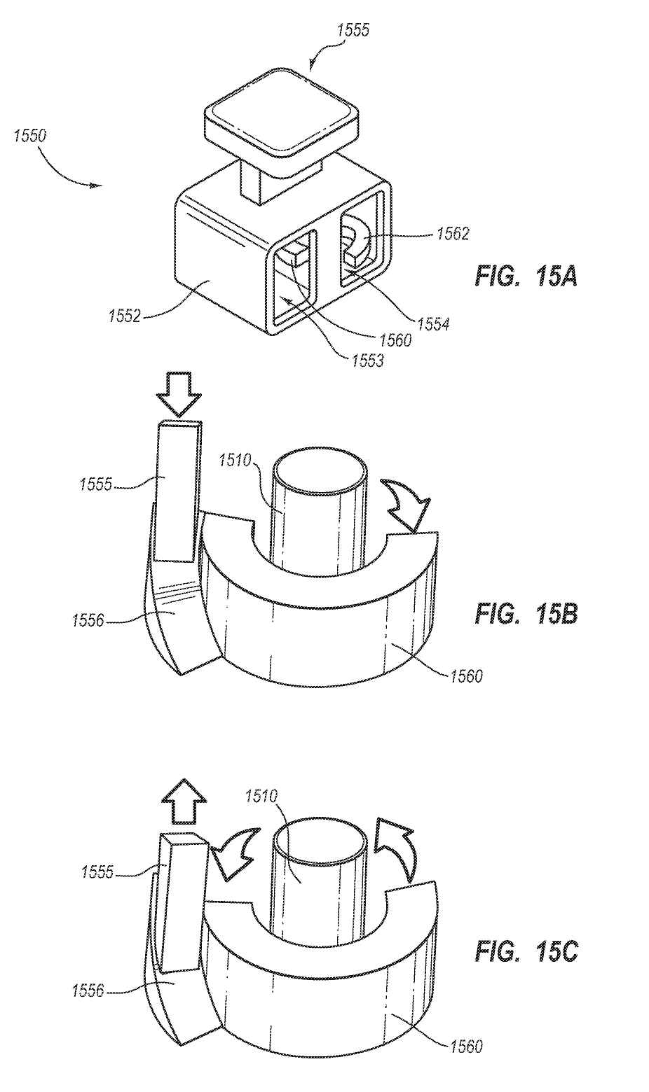

Still other embodiments of locking mechanisms are contemplated which also serve as adapters for pre-existing cable locks or other locks to operate and be used in conjunction with electronic devices configured with a security member, as described herein. More particularly, many laptop or portable computers today are pre-configured with a security slot which is designed to be engaged with a lock, often a cable lock. Because many users already have locks configured to be engaged with security slots, it would be useful to provide an adapter such that pre-existing locks can be used in conjunction with newer computers which may include security members, as described herein. FIGS. 15-17 depict example embodiments of such locking mechanisms/adapters.

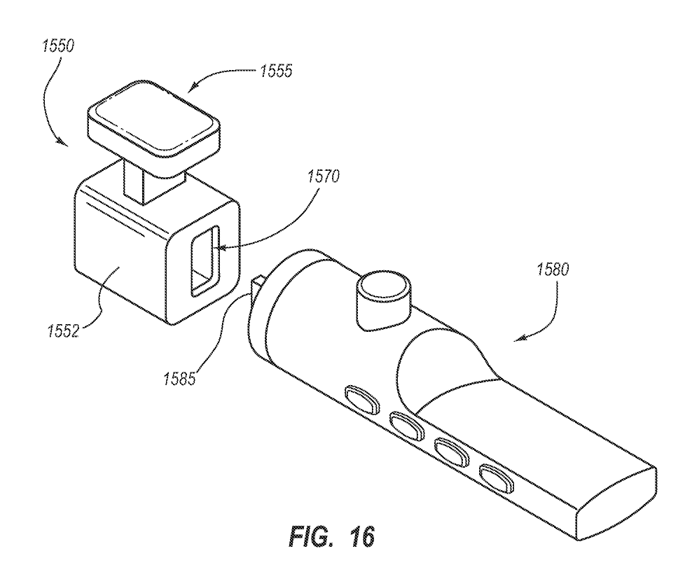

Thus, FIGS. 15A-15C and 16 depict a first embodiment of an adapter for allowing a lock configured to be engaged with a slot in a portable computer to be indirectly connected with a security member to secure the portable computer. As depicted in these figures, adapter 1550 comprises a housing 1552. A button 1555 is connected with the housing 1552 and is positioned above housing 1552. Similar to previous embodiments, locking mechanism 1550 also comprises upper and lower security arms 1560 and 1562, respectively. The security arms may be configured to extend out of one or more openings in the housing 1552. Thus, in the depicted embodiment, openings 1553 and 1554 are provided in one sidewall of the housing 1552. Upper security arm 1560 is configured to extend out of opening 1553 and lower security arm 1562 is configured to extend out of opening 1554. Thus, upon pressing button 1555, upper and lower security arms 1560 and 1562 extend out of openings 1553 and 1554 and approximate one another so as to wrap around and engage a security member (not shown in the figures) of a portable computer or another electronic device.

Alternatively, arms 1560 and 1562 may already extend out of their respective openings in housing 1552. In such embodiments, button 1555 may be configured to simply rotate the security arms around a security post. Thus, with reference now to FIGS. 15B and 15C, one example of the internal components of adapter 1550 is shown. As shown in these figures, one or both of security arms 1560 and 1562 may be connected with a ramp 1556. Thus, as illustrated in FIG. 15B, pressing button 1555 may result in security arm 1560 rotating away from a security post 1510, as indicated by the arrows in FIG. 15B.

Security arms 1560 and 1562 may be biased towards the position in which they engage security post 1510. In such embodiments, once button 1555 is released, security arm 1560 (along with security arm 1562, if desired) returns to its biased configuration by rotating about security post 1510. This action is indicated by the arrows in FIG. 15C. Thus, to couple adapter 1510 with a security post or another security member, button 1555 may be pushed and held while the adapter 1510 is put adjacent to and in position to engage the security post, after which button 1555 is released to engage one or more of the security arms with the security post. Of course, a lock, or another security feature described herein or available to one of ordinary skill in the art after having received the benefit of this disclosure, may be incorporated with the device to prevent release button 1555 from being actuated by unauthorized persons.

As illustrated in FIG. 16, a slot 1570 is provided in housing 1552 on a side of housing 1552 opposite to that in which openings 1553 and 1554 are formed. Slot 1570 is configured to receive a locking head 1585 of a computer lock device 1580. Adapter 1550 may be configured such that button 1555 is locked and does not function when locking head 1585 is engaged with slot 1570. Although the embodiment of FIGS. 15A-15C and 16 may be configured such that button 1555 serves to disengage the security arms from a security member, as described above, other embodiments are contemplated. For example, button 1555 may instead be configured to engage the security arms with the security member. In still other embodiments, button 1555 may be configured to both engage and disengage the security arms. For example, pressing the button down initially may engage and lock the security arms around the security member, after which upon pressing the button again, the security arms may be released from the security member.

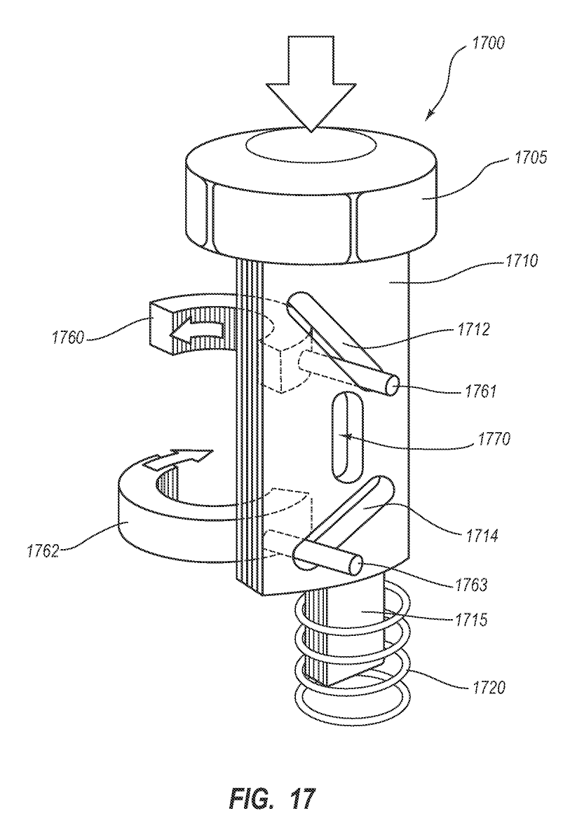

FIG. 17 depicts an example configuration of a button 1700 for use in an alternative embodiment of an adapter. Button 1700 comprises an actuation piece 1705 connected to a button body 1710. Button body 1710 comprises three slots. The centrally-located slot 1770 is configured to receive a portion of a lock device, such as locking head 1585 of computer lock device 1580 depicted in FIG. 16. Button body 1710 also comprises angled slots 1712 and 1714. As can be seen from FIG. 17, angled slot 1712 extends in a downward slant (left to right from the perspective of FIG. 17) across the side of button body 1710 and angled slot 1714 extends in an upward slant across the side of button body 1710. It can also be seen that the direction in which angled slot 1712 extends is approximately perpendicular to the direction in which angled slot 1714 extends.

Security arms 1760 and 1762 are each connected with a post which is slidably received in an angled slot such that, upon pressing down on the actuation piece 1705 of button 1700, the security arms move towards one another, as indicated by the arrows in FIG. 17. To be more specific, upper security arm 1760 is connected with post 1761, which is slidably received in slot 1712 and lower security arm 1762 is connected with post 1763, which is slidably received in slot 1714. As a downward force is applied to actuation piece 1705, post 1761 is forced towards the left end (from the perspective of FIG. 17) of button body 1710, due to the angling of slot 1712. This results in upper security arm 1760 being forced inward (or to the left), as indicated by the arrow. Likewise, a downward force on actuation piece 1705 results in post 1763 being forced to the right (again, from the perspective of FIG. 17) of button body 1710, which results in lower security arm 1762 also being forced inward (or to the right), as indicated by the arrow on lower security arm 1762. Pressing button 1700 therefore results in the two security arms being approximated with one another. It should therefore be appreciated that if a security member is positioned in between the two security arms, the two arms may be engaged with the security member. It should also be appreciated that, because the central slot 1770 is formed in the button body 1710, when a computer lock device is engaged with slot 1770, the button 1700 cannot be moved to release the security arm(s) from the security member. Thus, inserting a portion of a lock device in slot 1770 may result in arms 1760 and 1762 being locked around a security member (not shown) until the lock device is removed from slot 1770.

Button 1700 may also be spring-loaded. Thus, FIG. 17 depicts a spring 1720 wrapped around a lower piece 1715 of button 1700. Spring 1720 biases button 1700 upward which, in the depicted embodiment, results in security arms 1760 and 1762 being biased away from one another. However, other embodiments are contemplated in which a spring or other biasing element instead biases the device to a configuration in which the device is engaged with a security member. In such embodiments, the button may be pressed to disengage security arms and released to engage the security arms.

With reference to FIGS. 15-17, slots 1570 and 1770 are both examples of means for receiving a portion of a computer lock device. Security arms 1560 and 1562 are examples of means for releasably engaging a security member of a portable computer. Likewise, security arms 1760 and 1762 are examples of means for releasably engaging a security member of a portable computer. Buttons 1555 and 1700 are both examples of means for actuating a means for releasably engaging a security member of a portable computer.

As used herein, the term “module” is used to describe a given unit of functionality that can be performed in accordance with one or more embodiments of the present invention. As used herein, a module can be implemented utilizing any form of hardware, software, firmware, or a combination thereof. In implementation, the various modules described herein can be implemented as discrete modules or the functions and features described can be shared in part or in total among one or more modules. In other words, as would be apparent to one of ordinary skill in the art after reading this description, the various features and functionality described herein may be implemented in any given application in one or more separate or shared modules in various combinations and permutations. The term “tool” can be used to refer to any apparatus configured to perform a recited function. Tools can include a collection of one or more modules and can also be comprised of hardware, software, firmware, or a combination thereof. Thus, for example, a tool can be a collection of software modules, hardware modules, software/hardware modules, or any combination or permutation thereof. As another example, a tool can be a computing device or other appliance on which software runs or in which hardware is implemented.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to provide the desired features of the present invention. Also, a multitude of different constituent module names other than those depicted herein can be applied to the various partitions. Additionally, with regard to flow diagrams, operational descriptions, and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open-ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements, or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained, and can further be distributed across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

The above description fully discloses the invention including preferred embodiments thereof. Without further elaboration, it is believed that one skilled in the art can use the preceding description to utilize the invention to its fullest extent. Therefore, the examples and embodiments disclosed herein are to be construed as merely illustrative and not a limitation of the scope of the present invention in any way.

It will be obvious to those having skill in the art that many changes may be made to the details of the above-described embodiments without departing from the underlying principles of the invention. The scope of the present invention should, therefore, be determined only by the following claims.

1. A locking system comprising:
an electronic device;
a security member connected with the electronic device;
a locking mechanism configured to be releasably secured to the security member; and
a lock sensor configured to detect the presence of the locking mechanism.

2. The locking system of claim 1, wherein the electronic device further comprises a lock module configured to receive data from the lock sensor.

3. The locking system of claim 2, wherein the lock module is configured to disable an operation of the electronic device in response to the lock sensor detecting the absence of the locking mechanism.

4. The locking system of claim 2, wherein the lock module is configured to restrict access to the electronic device in response to the lock sensor detecting the absence of the locking mechanism.

5. The locking system of claim 2, wherein the lock module is configured to require the performance of a security operation in response to the lock sensor detecting that the locking mechanism has been removed from the electronic device.

6. The locking system of claim 5, wherein the security operation comprises user input of a password.

7. The locking system of claim 1, wherein the lock sensor detects the presence of the locking mechanism by contacting at least a portion of the locking mechanism.

8. The locking system of claim 7, wherein the lock sensor comprises at least one electrical contact configured to mate with a corresponding electrical contact on the locking mechanism.

9. The locking system of claim 8, wherein the at least one electrical contact comprises a female electrical jack configured to receive a male electrical plug on the locking mechanism.

10. The locking system of claim 8, wherein the at least one electrical contact is configured to allow for data transfer between the locking mechanism and the lock sensor.

11. A locking system comprising:
an electronic device comprising a housing;
a recessed portion located in the housing; and
a security member located within the recessed portion and configured to be releasably engaged with the locking mechanism.

12. The locking system of claim 11, wherein the electronic device further comprises a lock sensor configured to detect the presence of the locking mechanism.

13. The locking system of claim 11, wherein the security member comprises a security post.

14. The locking system of claim 11, wherein the recessed portion is located in a corner of the housing.

15. The locking system of claim 11, wherein the security member comprises a retractable receptor for receiving the locking mechanism, wherein the retractable receptor is configured to be positioned in a retracted configuration in which the retractable receptor is positioned within the recessed portion and be selectively extended to an extended configuration in which the retractable receptor extends outside the recessed portion.

16. An electronic device comprising:
a housing;
a recess formed in the housing; and
a retractable receptor for receiving a locking mechanism, wherein the retractable receptor is configured to be positioned in a retracted configuration in which the retractable receptor is positioned within the recess and be selectively extended to an extended configuration in which the retractable receptor extends outside the recess.

17. The electronic device of claim 16, wherein the retractable receptor in the retracted configuration is configured to be extended to the extended configuration by applying a force towards the recess to unlock the retractable receptor and allow the retractable receptor to automatically extend to the extended configuration.

18. The electronic device of claim 17, further comprising a spring to bias the retractable receptor towards the extended configuration.

19. The electronic device of claim 16, wherein the retractable receptor is configured to extend straight out of the recess from the retracted configuration to the extended configuration.

20. The electronic device of claim 16, wherein the retractable receptor is configured to pivot out of the recess from the retracted configuration to the extended configuration.

21. The electronic device of claim 16, wherein the retractable receptor comprises an aperture accessible only in the extended configuration, and wherein the aperture is configured to receive a locking mechanism for securing the electronic device.

22. An adapter for allowing a lock configured to be engaged with a slot in a portable computer to be indirectly connected with a security member to secure the portable computer, the adapter comprising:
a slot configured to receive a portion of a computer lock device; and
a security arm configured to releasably engage a security member of a portable computer.

23. The adapter of claim 22, further comprising a button configured to actuate engagement of the security arm with the security member.

24. The adapter of claim 23, wherein the button comprises an angled slot, and wherein the security arm is connected with a post which is slidably received in the angled slot such that, upon pressing the button, the security arm moves.

25. The adapter of claim 24, further comprising a second security arm, wherein the button comprises a second angled slot, wherein the second security arm is connected with a second post which is slidably received in the second angled slot such that, upon pressing the button, the second security arm moves towards the security arm.

26. The adapter of claim 23, wherein the button is spring-loaded.

27. The adapter of claim 23, wherein the slot is formed in the button such that, when the computer lock device is engaged with the slot, the button cannot be moved to release the security arm from the security member.

28. The adapter of claim 22, further comprising a second security arm.

29. The adapter of claim 28, wherein the security arm is configure to engage the security member on a first side of the security member, and wherein the second security arm is configured to engage the security member on a second side of the security member at least approximately opposite from the first side.

30. An adapter for allowing a lock configured to be engaged with a slot in a portable computer to be indirectly connected with a security member to secure the portable computer, the adapter comprising:
means for receiving a portion of a computer lock device;
means for releasably engaging a security member of a portable computer; and
means for actuating the means for releasably engaging.

31. The adapter of claim 30, wherein the means for receiving comprises a slot.

32. The adapter of claim 30, wherein the means for releasably engaging comprises a security arm configured to releasably engage the security member.

33. The adapter of claim 30, wherein the means for actuating comprises a button.
